(19) United States
(12) Patent Application Publication
(10) Pub. No.: US 2002/0158732 A1
(43) Pub. Date: Oct. 31, 2002

(54) Electronic trip unit interlock for circuit breakers

(76) Inventors: Roger Neil Castonguay, Terryville, CT (US); Dean Arthur Robarge, Southington, CT (US); Girish Mruthunjaya Hassan, Seconderabad (IN)

Correspondence Address: CANTOR COLBURN, LLP, 55 GRIFFIN ROAD SOUTH, BLOOMFIELD, CT, 06002

(21) Appl. No.: 09/681,564

(22) Filed: Apr. 30, 2001

(51) Int. Cl. H01H 9/00

(52) U.S. Cl. 335/172

(57) ABSTRACT

An operating mechanism for a circuit breaker comprises: an operating handle movable between on and off positions extending substantially up at a point between the on and off positions; a crank for controlling a contact arm of the circuit breaker to cause the contact arm to move between open and closed positions; mechanism spring connected between the operating handle and the crank, causing said crank to move when discharged and when the operating handle is moved between said on and off positions; a trip latch configured to restrain the mechanism spring from discharging unless moved; and means for moving the trip latch upon removal of an electronic trip unit.

### BACKGROUND OF INVENTION

The present invention is directed to circuit breakers, and more particularly to interlock mechanisms to trip the circuit breaker when an electronic trip unit is separated therefrom.

Circuit breakers include movable and fixed contacts for opening and closing the distribution circuit and an operating handle for manually operating the contacts. Modern industrial circuit breakers are normally provided with an electronic trip unit that electronically monitors the current levels in the circuit and trips the circuit breaker in response to a detected fault condition. Sometimes, it is convenient or necessary to remove or replace the electronic trip unit. Removing the electronic trip unit while the contacts are closed creates an obvious safety risk. Therefore, it is desirable to provide some means for preventing the contacts from being closed when the trip unit is not installed in the circuit breaker, and for causing the circuit breaker to trip, thereby separating the contacts, upon removal of the trip unit from the circuit breaker.

Prior art circuit breakers having removable trip units have a portion of the main operating mechanism built into the trip unit such that when the trip unit is removed, part of the operating mechanism is also removed, making it impossible to close the main contacts. This technique increases the complexity of installation and removal of the electronic trip unit, and the expense of the trip unit. Furthermore, electronic trip units must be manufactured particularly for each model of circuit breaker.

### SUMMARY OF INVENTION

The above discussed and other drawbacks and deficiencies are overcome or alleviated by an operating mechanism for a circuit breaker. The operating mechanism comprises an operating handle movable between on and off positions extending substantially up at a point between the on and off positions; a crank for controlling a contact arm of the circuit breaker to cause the contact arm to move between open and closed positions; mechanism spring connected between the operating handle and the crank, causing said crank to move when discharged and when the operating handle is moved between said on and off positions; a trip latch configured to restrain the mechanism spring from discharging unless moved; and means for moving the trip latch upon removal of an electronic trip unit.

The above-discussed and other features and advantages of the present invention will be appreciated and understood by those skilled in the art from the following detailed description and drawings.

### BRIEF DESCRIPTION OF DRAWINGS

Referring to the Figures wherein like elements are numbered alike in the several Figures

FIG. 1 is an isometric view of an industrial-rated molded case circuit breaker;

FIG. 2 is an exploded view of the circuit breaker of FIG. 1;

FIG. 3 is a side view of a rotary contact assembly in an “off” condition;

FIG. 4 is a side view of a rotary contact assembly in an “on” condition;

FIG. 5 is a side view of a rotary contact assembly in a “tripped” condition;

FIG. 6 is a perspective view of an operating mechanism;

FIG. 7 is a partially exploded perspective view of the operating mechanism of FIG. 6;

FIG. 8 is a partially exploded perspective view of the operating mechanism of FIG. 6;

FIG. 9 is a partially exploded perspective view of a portion of the operating mechanism of FIG. 6 including a pair of mechanism springs;

FIG. 10 is an exploded perspective view of a cradle from the operating mechanism of FIG. 6;

FIG. 11 is a perspective view of the cradle of FIG. 10;

FIG. 12 is partially exploded view of an operating mechanism and electronic trip unit interlock;

FIG. 13 is a perspective view of the operating mechanism of FIG. 6, with the trip unit interlock installed thereon;

FIG. 14 is a top view of internal parts of the circuit breaker of FIG. 1 with the trip unit interlock installed;

FIG. 15 is a partially-assembled view of the circuit breaker of FIG. 1 showing interaction between the electronic trip unit and interlock mechanism;

FIG. 16 shows the circuit breaker of FIG. 1, with the top cover lifted;

FIG. 17 is close up view of a portion of FIG. 16; and

FIG. 18 is a profile view of the operating and trip unit interlock mechanisms.

### DETAILED DESCRIPTION

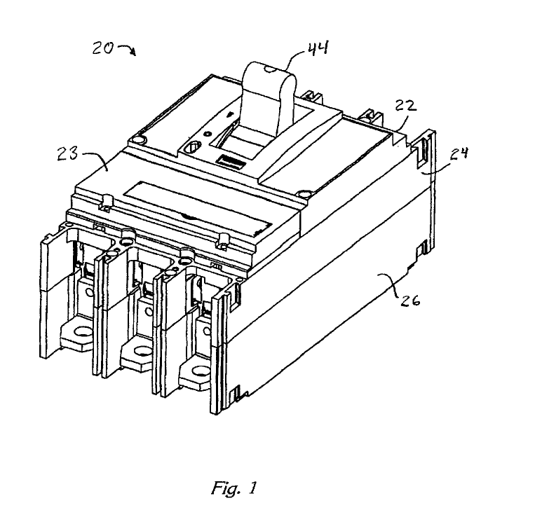

FIG. 1 shows a circuit breaker 20. Circuit breaker 20 generally includes a molded case having a top cover 22 attached to a mid cover 24 coupled to a base 26.

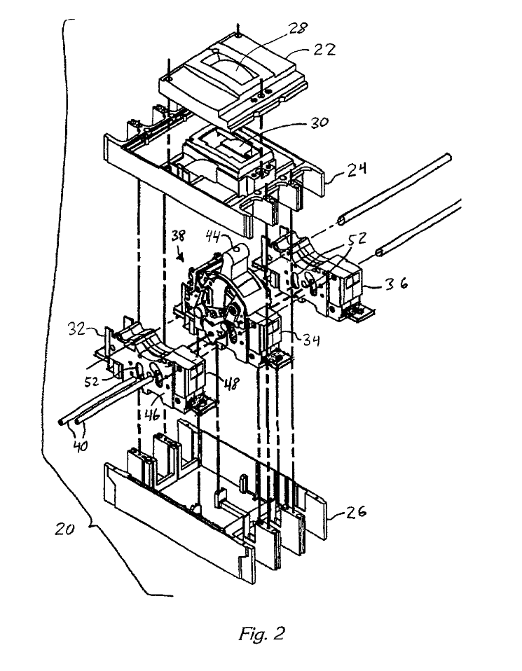

FIG. 2 shows an exploded diagram of circuit breaker 20, showing the internal construction thereof. An opening 28, formed generally centrally within top cover 22, is positioned to mate with a corresponding mid cover opening 30, which is accordingly aligned with opening 28 when mid cover 24 and top cover 22 are coupled to one another. Electronic trip unit 23 is removably positioned within top cover 22 as shown.

In a 3-pole system (i.e., corresponding with three phases of current), three rotary cassettes 32, 34 and 36 are disposed within base 26. Cassettes 32, 34 and 36 are commonly operated by an interface between an operating mechanism 38 via a cross pin 40. Operating mechanism 38 is positioned and configured atop cassette 34, which is generally disposed intermediate to cassettes 32 and 36. Operating mechanism 38 operates substantially as described herein and as described in U.S. Pat. No. 6,087,913 entitled “Circuit Breaker Mechanism for a Rotary Contact Assembly”.

An operating handle 44 extends through openings 28 and 30 and allows for external operation of cassettes 32, 34 and 36. Examples of rotary contact structures that may be operated by operating mechanism 38 are described in more detail in U.S. Pat. Nos. 6,114,641 and 09/384,908 (GE Docket Number 41PR7613/7619), both entitled “Rotary Contact Assembly For High-Ampere Rated Circuit Breakers”, and U.S. Pat. No. 6,175,288 entitled “Supplemental Trip Unit For Rotary Circuit Interrupters”. Cassettes 32, 34, 36 are typically formed of high strength plastic material and each include opposing sidewalls 46, 48. Sidewalls 46, 48 have an arcuate slot 52 positioned and configured to receive and allow the motion of cross pins 40 by action of operating mechanism 38.

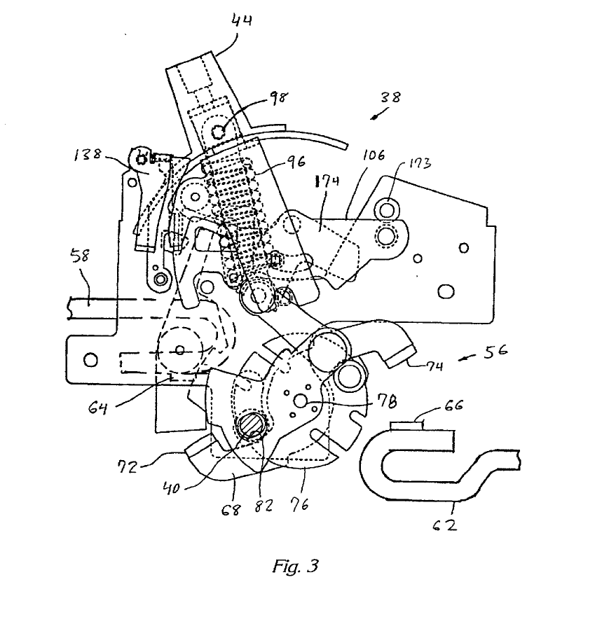

Referring now to FIGS. 3, 4, and 5, an exemplary rotary contact assembly 56 that is disposed within each cassette 32, 34, 36 is shown in the “off”, “on” and “tripped” conditions, respectively. Also depicted are partial side views of operating mechanism 38, the components of which are described in greater detail further herein. Rotary contact assembly 56 includes a load side contact strap 58 and line side contact strap 62 for connection to a power source and a protected circuit (not shown), respectively. Load side contact strap 58 includes a stationary contact 64 and line side contact strap 62 includes a stationary contact 66. Rotary contact assembly 56 further includes a movable contact arm 68 having a set of contacts 72 and 74 that mate with stationary contacts 64 and 66, respectively. In the “off” position (FIG. 3) of operating mechanism 38, wherein operating handle 44 is oriented to the left (e.g., via a manual or mechanical force), contacts 72 and 74 are separated from stationary contacts 64 and 66, thereby preventing current from flowing through contact arm 68. It should be appreciated that while rotary contact assembly 56 shows a contact arm having a pair of movable contacts, rotary contact assemblies wherein the contact arm has only a single movable contact is contemplated.

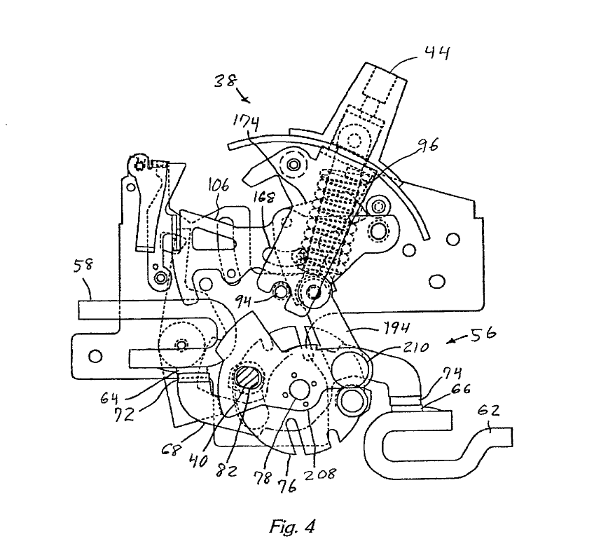

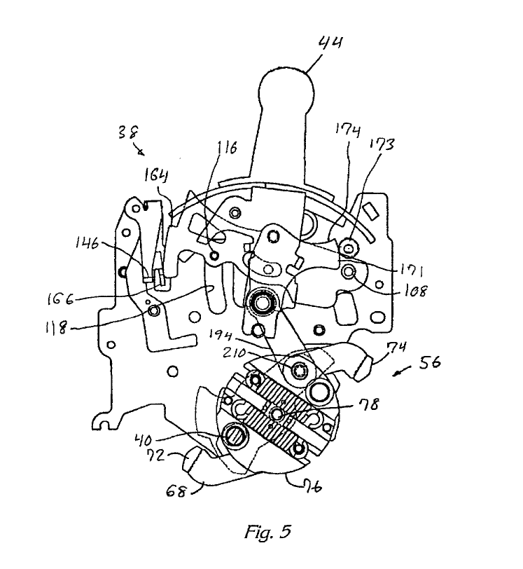

In the “on” position of operating mechanism 38 shown in FIG. 4, wherein operating handle 44 is oriented to the right as depicted in FIG. 4 (e.g., via a manual or mechanical force), contacts 72 and 74 are mated with stationary contacts 64 and 66, thereby allowing current to flow through contact arm 68. In the “tripped” position shown in FIG. 5, operating handle 44 is oriented between the “on” position and the “off” positions (typically by the release of mechanism springs within operating mechanism 38, described in greater detail herein). In this “tripped” position, contacts 72 and 74 are separated from stationary contacts 64 and 66 by the action of operating mechanism 38, thereby preventing current from flowing through contact arm 68. After operating mechanism 38 is in the “tripped” position, it must ultimately be returned to the “on” position for operation. This is effectuated by applying a reset force to move operating handle 44 to a “reset” condition, which is beyond the “off” position (i.e., further to the left of the “off” position in FIG. 3), and then back to the “on” position. This reset force must be high enough to overcome the mechanism springs, described herein.

Contact arm 68 is mounted on a rotor structure 76 that houses one or more sets of contact springs. Contact arm 68 and rotor structure 76 pivot about a common center 78. Cross pin 40 interfaces through an opening 82 within rotor structure 76 generally to cause contact arm 68 to be moved from the “on”, “off” and “tripped” position.

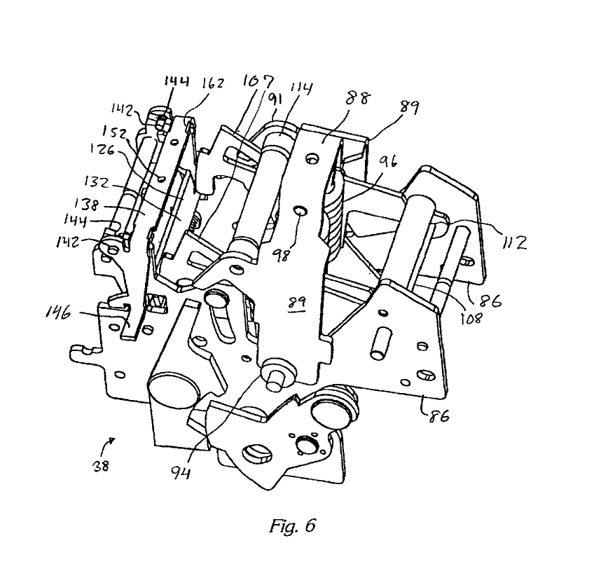

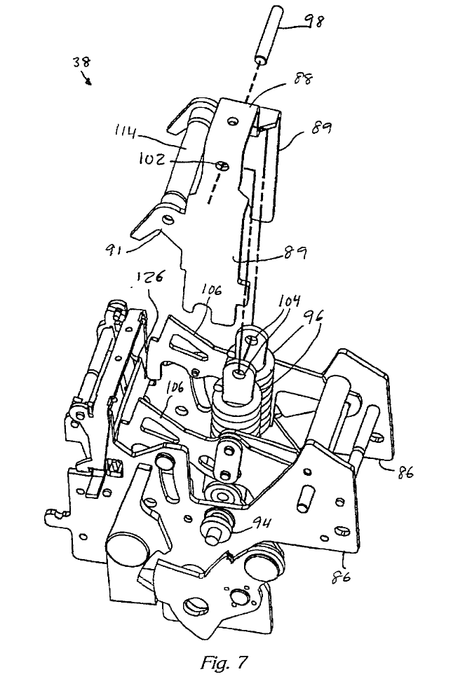

Referring now to FIGS. 6-8, the components of operating mechanism 38 will now be detailed. As viewed in FIGS. 6-8, operating mechanism 38 is in the “tripped” position. Operating mechanism 38 has operating mechanism side frames 86 configured and positioned to straddle sidewalls 46, 48 of cassette 34 (FIG. 2).

Operating handle 44 (FIGS. 2-4) is rigidly interconnected with a drive member or handle yoke 88. Handle yoke 88 includes opposing side portions 89. Each side portion 89 includes an extension 91 at the top of side portion 89, and a U-shaped portion 92 at the bottom portion of each side portion 89. U-shaped portions 92 are rotatably positioned on a pair of bearing portions 94 protruding outwardly from side frames 86. Bearing portions 94 are configured to retain handle yoke 88, for example, with a securement washer. Handle yoke 88 further includes a roller pin 114 extending between extensions 91.

Handle yoke 88 is connected to a set of powerful mechanism springs 96 by a spring anchor 98, which is generally supported within a pair of openings 102 in handle yoke 88 and arranged through a complementary set of openings 104 on the top portion of mechanism springs 96.

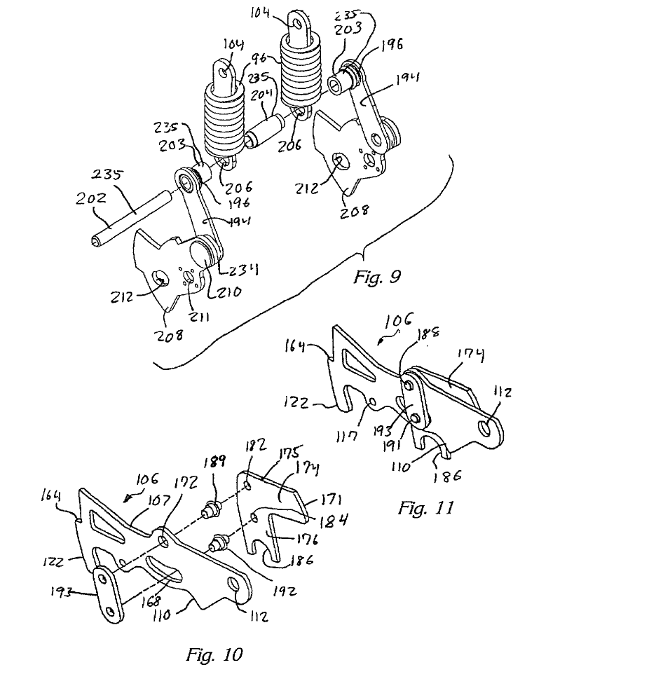

Referring to FIG. 9, the bottom portion of mechanism springs 96 include a pair of openings 206. A drive connector 201235 operatively couples mechanism springs 96 to other operating mechanism components. Drive connector 201235 comprises a pin 202 disposed through openings 206, a set of side tubes 203 arranged on pin 202 adjacent to the outside surface of the bottom portion of mechanism springs 96, and a central tube 204 arranged on pin 202 between the inside surfaces of the bottom portions of mechanism springs 96. Central tube 204 includes step portions at each end, generally configured to maintain a suitable distance between mechanism springs 96. While drive connector 201235 is detailed herein as tubes 203, 204 and a pin 202, any means to connect the springs to the mechanism components are contemplated.

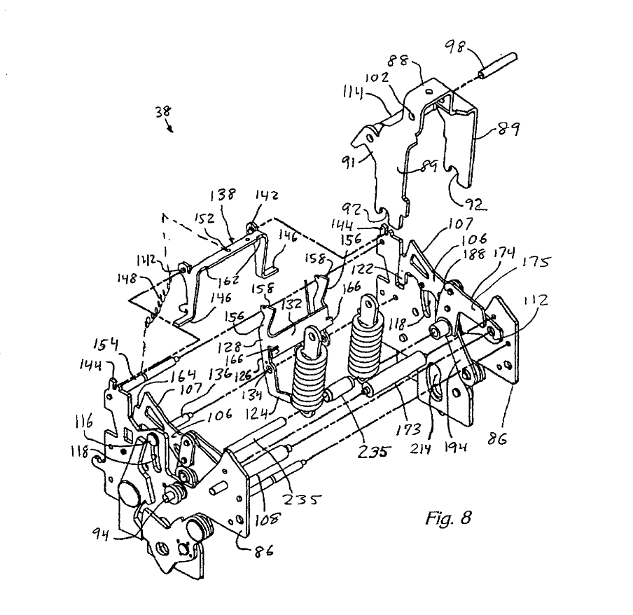

Referring to FIGS. 8, 10, and 11, a pair of cradles 106 are disposed adjacent to side frames 86 and pivot on a pin 108 disposed through an opening 112 approximately at the end of each cradle 106. Each cradle 106 includes an edge surface 107, an arm 122 depending downwardly, and a cradle latch surface 164 above arm 122. Edge surface 107 is positioned generally at the portion of cradle 106 in the range of contact with roller pin 114. Each cradle 106 also includes a stop surface 110 formed thereon. A rivet 116 disposed through an arcuate slot 118 within each side frame 86, as best seen in FIGS. 5 and 8, guides the movement of each cradle 106. Rivets 116 are disposed within an opening 117 on each cradle 106 (FIG. 11). An arcuate slot 168 is positioned intermediate to opening 112 and opening 117 on each cradle 106. An opening 172 is positioned above slot 168.

Referring back to FIGS. 6-8, a primary latch 126 is positioned within side frames 86. Primary latch 126 includes a pair of side portions 128 (FIG. 8). Each side portion 128 includes a bent leg 124 at the lower portion thereof. Side portions 128 are interconnected by a central portion 132. A set of extensions 166 depend outwardly from central portion 132 positioned to align with cradle latch surfaces 164.

Side portions 128 each include an opening 134 positioned so that primary latch 126 is rotatably disposed on a pin 136. Pin 136 is secured to each side frame 86. A set of upper side portions 156 are defined at the top end of side portions 128. Each upper side portion 156 has a primary latch surface 158.

A secondary latch 138 is pivotally straddled over side frames 86. Secondary latch 138 includes a set of pins 142 disposed in a complementary pair of notches 144 on each side frame 86. Secondary latch 138 includes legs 139 each having a secondary latch trip tab 146 that extends perpendicularly from operating mechanism 38. Secondary latch 138 includes a set of latch surfaces 162, that align with primary latch surfaces 158.

Secondary latch 138 is biased in the clockwise direction due to the pulling forces of a spring 148 (FIG. 8). Spring 148 has a first end connected at an opening 152 upon secondary latch 138, and a second end connected at a frame cross pin 154 disposed between frames 86.

A set of upper links 174 are connected to cradles 106. Upper links 174 generally have a right angle shape, as best viewed in FIGS. 8 and 10. Legs 175 (in a substantially horizontal configuration in FIG. 10) of upper links 174 each have a cam surface 171 that interfaces a roller 173 disposed between frames 86 (FIG. 8). Legs 176 (in a substantially vertical configuration in FIGS. 8 and 10) of upper links 174 each have a pair of openings 182, 184 and a U-shaped portion 186 at the bottom end thereof. Opening 184 is intermediate to opening 182 and U-shaped portion 186. Upper links 174 connect to cradle 106 via a securement structure such as a rivet pin 188 disposed through opening 172 and opening 182, and a securement structure such as a rivet pin 191 disposed through slot 168 and opening 184. Rivet pins 188, 191 (FIG. 11) both attach to a connector 193 to secure each upper link 174 to each cradle 106. Each pin 188, 191 includes raised portions 189, 192, respectively. Raised portions 189, 192 are provided to maintain a space between each upper link 174 and each cradle 106. The space serves to reduce or eliminate friction between upper link 174 and cradle 106 during any operating mechanism motion, and also to spread force loading between cradles 106 and upper links 174.

Upper links 174 are each interconnected with a lower link 194. Referring now to FIGS. 8 and 9, U-shaped portion 186 of each upper link 174 is disposed in a complementary set of bearing washers 196. Bearing washers 196 are arranged on each side tube 203. Bearing washers 196 are configured to include side walls spaced apart sufficiently so that U-shaped portions 186 of upper links 174 fit in bearing washer 196. Pin 202 is disposed through side tubes 203 and central tube 204. Pin 202 interfaces upper links 174 and lower links 194 via side tubes 203. Therefore, each side tube 203 is a common interface point for upper link 174 (as pivotally seated within side walls of bearing washer 196), lower link 194 and mechanism springs 96.

Each lower link 194 is interconnected with a crank 208 via a pivotal rivet 210. Each crank 208 pivots about a center 211 . Crank 208 has an opening 212 where cross pin 40 (FIG. 2) passes through into arcuate slot 52 of cassettes 32, 34 and 36 and a complementary set of arcuate slots 214 on each side frame 86 (FIG. 8).

A spacer 234 is included on each pivotal rivet 210 between each lower link 194 and crank 208. Spacers 234 spread the force loading from lower links 194 to cranks 208 over a wider base, and also reduces friction between lower links 194 and cranks 208, thereby minimizing the likelihood of binding (e.g., when operating mechanism 38 is changed from the “off” position to the “on” position manually or mechanically, or when operating mechanism 38 is changed from the “on” position to the “tripped” position of the release of primary latch 126 and secondary latch 138).

Referring back to FIGS. 3-5, the movement of operating mechanism 38 relative to rotary contact assembly 56 will be detailed.

Referring to FIG. 3, in the “off” position operating handle 44 is rotated to the left and mechanism springs 96, lower link 194 and crank 208 are positioned to maintain contact arm 68 so that movable contacts 72, 74 remain separated from stationary contacts 64, 66. Operating mechanism 38 becomes set in the “off” position after a reset force properly aligns primary latch 126, secondary latch 138 and cradle 106 (e.g., after operating mechanism 38 has been tripped) and is released. Thus, when the reset force is released, extensions 166 of primary latch 126 rest upon cradle latch surfaces 164, and primary latch surfaces 158 rest upon secondary latch surfaces 162. Each upper link 174 and lower link 194 are bent with respect to each side tube 203. The line of forces generated by mechanism springs 96 (i.e., between spring anchor 98 and pin 202) is to the left of bearing portion 94 (as oriented in FIGS. 3-5). Cam surface 171 of upper link 174 is out of contact with roller 173.

Referring now to FIG. 4, a manual closing force was applied to operating handle 44 to move it from the “off” position (i.e., FIG. 4) to the “on” position (i.e., to the right as oriented in FIG. 5). While the closing force is applied, upper links 174 rotate within arcuate slots 168 of cradles 106 about pins 188, and lower link 194 is driven to the right under bias of the mechanism spring 96. Side walls of bearing washers 196 maintain the position of upper link 174 on side tube 203 and minimize likelihood of binding (e.g., so as to prevent upper link 174 from shifting into springs 96 or into lower link 194).

To align vertical leg 176 and lower link 194, the line of force generated by mechanism springs 96 is shifted to the right of bearing portion 94, which causes rivet 210 coupling lower link 194 and crank 208 to be driven downwardly and to rotate crank 208 clockwise about center 211. This, in turn, drives cross pin 40 to the upper end of arcuate slot 214. Therefore, the forces transmitted through cross pin 40 to rotary contact assembly 56 via opening 82 drive movable contacts 72, 74 into stationary contacts 64, 66.

The interface between primary latch 126 and secondary latch 138 (i.e., between primary latch surface 158 and secondary latch surface 162), and between cradles 106 and primary latch 126 (i.e., between extensions 166 and cradle latch surfaces 164) is not affected when a force is applied to operating handle 44 to change from the “off” position to the “on” position.

Referring again to FIG. 5, in the “tripped” condition, secondary latch trip tab 146 has been displaced, e.g., by electronic trip unit interlock, described in detail below, and the interface between primary latch 126 and secondary latch 138 is released. Extensions 166 of primary latch 126 are disengaged from cradle latch surfaces 164, and cradles 106 is rotated clockwise about pin 108 (i.e., motion guided by rivet 116 in arcuate slot 118). The movement of cradle 106 transmits a force via rivets 188, 191 to upper link 174 having cam surface 171. After a short predetermined rotation, cam surface 171 of upper link 174 contacts roller 173. The force resulting from the contact of cam surface 171 on roller 173 causes upper link 174 and lower link 194 to buckle and allows mechanism springs 96 to pull lower link 194 via pin 202. In turn, lower link 194 transmits a force to crank 208 (i.e., via rivet 210) causing crank 208 to rotate counter clockwise about center 211 and drive cross pin 40 to the lower portion of arcuate slot 214. The forces transmitted through cross pin 40 to rotary contact assembly 56 via opening 82 cause movable contacts 72, 74 to separate from stationary contacts 64, 66.

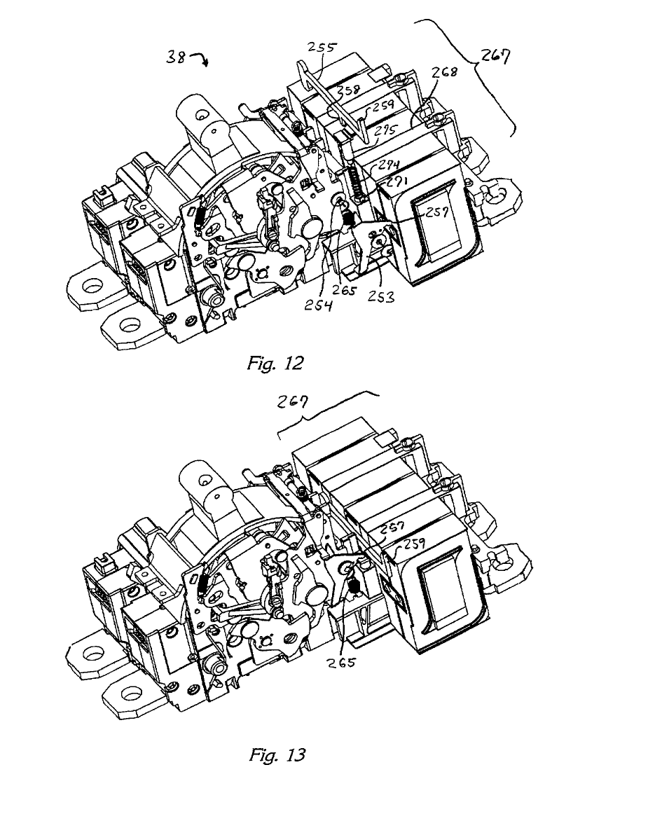

Referring now to FIGS. 12-18, the electronic trip unit interlock mechanism will be described in detail. FIGS. 12 and 13 show isometric views of circuit breaker 20 rotated approximately 180 degrees about a central axis relative to FIG. 1. FIG. 12 shows the components of the electronic trip unit interlock are separated from the operating mechanism and FIG. 13 shows the components installed. In each of FIGS. 12 and 13, the top cover 22, mid cover 24, and base 26 removed and the outside cassette 36 is not shown for clarity. The trip arm 253 is mounted to the side of operating mechanism 38 as shown and rotates about a fixed pivot 254. Trip arm 253 includes a leg 257 having a first surface in contact with trip plunger 275 and an extension 270 having a latch surface for contacting secondary trip latch 138. Extension bar 255 is positioned between operating mechanism 38 and breaker load vent assembly 267. Extension bar includes a finger 259 having a first surface that comes into contact with electronic trip unit 23 when it is installed, and a nub 258 having a second surface in contact with trip plunger 275. Center barrier 268 contains a bored hole 271 located as shown. Trip spring 274 and trip plunger 275 are positioned within hole 271. FIG. 13 shows the trip plunger 275 positioned under leg 257 of trip arm 253.

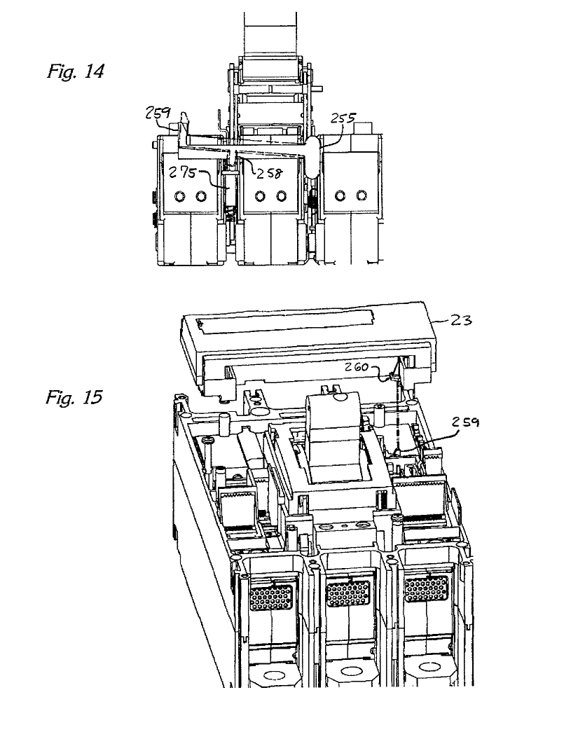

FIG. 14 shows extension bar 255 as it interacts with trip plunger 275. When extension bar 255 is in the position shown, it holds trip plunger 275 in its depressed position away from leg 257 of trip arm 253. When extension bar 255 is allowed to move, to the position shown in phantom in FIG. 14, it allows trip plunger 275 to be driven in an upwards direction by trip spring 274 into an interference with leg 257 of trip lever 253. Extension bar 255 is held in the position which depresses trip plunger 275 when the electronic trip unit 23 is installed in circuit breaker 20 as shown in FIG. 15. When electronic trip unit 23 is removed, extension bar 255 is released, allowing trip plunger 275 to move in an upwards direction, moving extension bar 255 to the phantom position shown in FIG. 14.

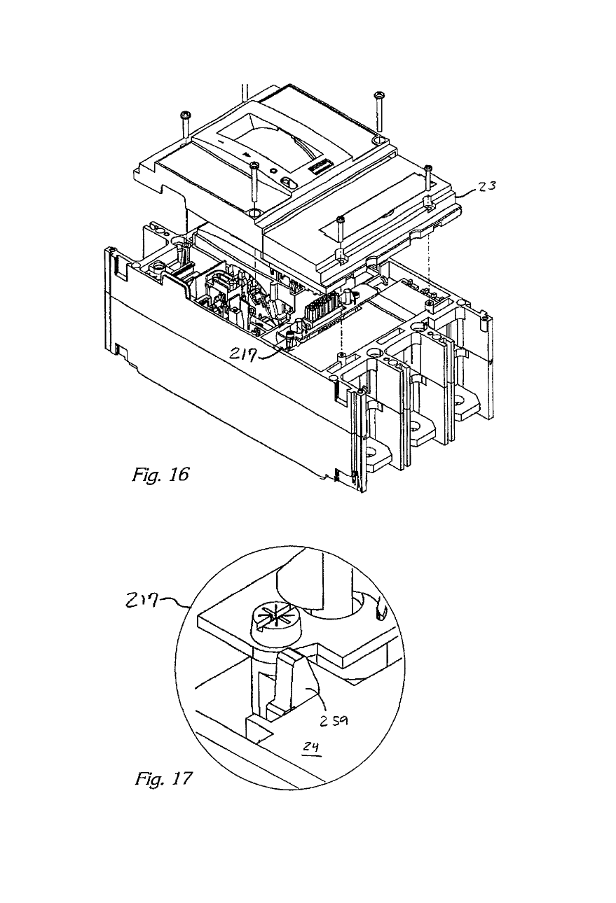

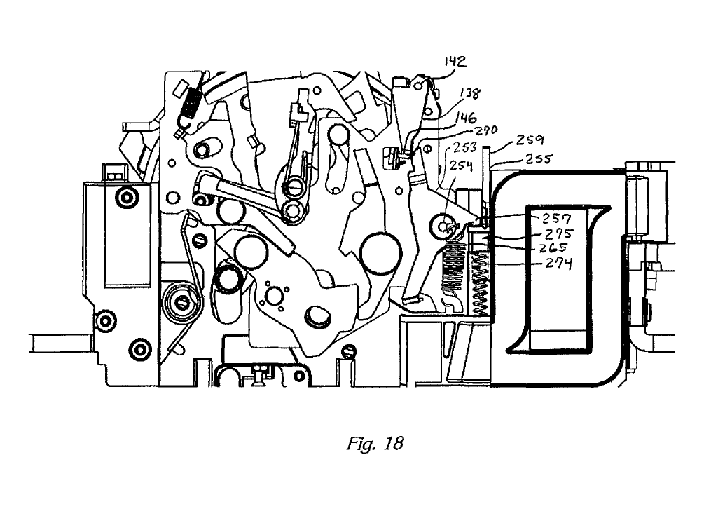

FIG. 16 clarifies the relationship between finger 259 of extension bar 255 as it relates to mid cover 24 and electronic trip unit 23. FIG. 17 shows a detail of a portion 217 of FIG. 16, showing finger 259 extending up from mid cover 24.

Referring now to FIG. 18, in response to electronic trip unit 23 being removed, spring 274 has urged plunger 275 in an upward direction, causing extension bar 255 to move up and trip arm 253 to rotate in a counter-clockwise direction about pivot 254. Extension 270 of trip arm 253 includes a latch surface that interacts with secondary latch trip tab 146 of secondary latch 138. In response to this interaction, secondary latch 138 is caused to rotate in a clockwise direction about pins 142, causing the operating mechanism to trip as previously described, separating movable contacts 74, 72 from fixed contacts 66, 64. Unless electronic trip unit 23 is replaced, the operating mechanism will remain in this position and will not allow the main contacts to be closed.

When trip unit 23 is replaced as shown in FIG. 15, surface 260 interacts with finger 259 of extension bar 255, forcing extension bar 255 to rotate downwardly. When extension bar is forced down, nub 258 forces plunger 275 to become depressed, as shown in FIG. 14. In response to plunger 275 being depressed, trip arm 253 is permitted to rotate clockwise about pivot 254. Spring 265 (FIGS. 13, 18) urges trip arm 253 to rotate in a clockwise direction, thus causing trip arm 253 to rotate in a clockwise direction when free to do so.

While the invention has been described with reference to a preferred embodiment, it will be understood by those skilled in the art that various changes may be made and equivalents may be substituted for elements thereof without departing from the scope of the invention. For example, trip arm 253 may be mounted and configured to slide instead of rotate, and/or may engage an intermediary which then actuates secondary trip latch 138, rather than actuating secondary trip latch 138 directly. Additionally, electronic trip unit 23 may engage a surface of trip arm 253 or other intermediary rather than work directly against plunger 275. These and other modifications would occur to the skilled artisan to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. An operating mechanism for a circuit breaker, said operating mechanism comprising:
an operating handle movable between on and off positions, said operating handle extending substantially up at a point between said on and off positions;
a crank for controlling a contact arm of the circuit breaker thereby causing said contact arm to move between open and closed positions when said crank moved;
a mechanism spring connected between said operating handle and said crank, causing said crank to move when discharged and when said operating handle is moved between said on and off positions;
a trip latch configured to restrain said mechanism spring from discharging unless moved; and
means for moving the trip latch upon removal of an electronic trip unit.

2. The operating mechanism set forth in claim 1 wherein said means for moving includes:
a trip arm movable between a first position and a second position, said trip arm including a latch surface positioned to interact with said trip latch such that as said trip arm is moved from said first position to said second position, said latch surface engages and moves said trip latch, causing said mechanism spring to discharge,
means for biasing said trip arm toward said second position, and
means for preventing said means for biasing from moving said trip arm toward said second position in response to the presence of said electronic trip unit.

3. The operating mechanism set forth in claim 2 wherein:
said means for biasing comprises a plunger and a trip spring, said trip spring biasing said plunger toward an extended position.

4. The operating mechanism set forth in claim 3 wherein:
said means for preventing comprises an extension bar that includes a first surface that interacts with said electronic trip unit, said extension bar being positioned to interact with electronic trip unit such that said electronic trip unit forces a second surface of said extension bar to depress said plunger against the force of said trip spring when said electronic trip unit is installed.

5. An operating mechanism for a circuit breaker comprising:
an extension bar;
a plunger positioned to interact with said extension bar, said plunger being forced into a depressed position by said extension bar when said extension bar is forced into a first position, said extension bar being positioned proximate said plunger and a location adapted for an installation of an electronic trip unit, said extension bar being forced into said first position when said electronic trip unit is installed at said location;
a trip spring urging said plunger into an extended position, said trip spring urging said extension bar into a second position when said electronic trip unit is not present; and
means for tripping said operating mechanism in response to said plunger being in said extended position.

6. The operating mechanism set forth in claim 5, wherein said extension bar is not fixedly attached to said electronic trip unit.

7. The operating mechanism set forth in claim 5, wherein said extension bar is not fixedly attached to said plunger.

8. The operating mechanism set forth in claim 5, wherein said means for tripping comprises:
a trip arm having a first surface and a latch surface, said first surface of said trip arm interacting with said plunger and said latch surface interacting with a trip latch, said trip arm being configured and positioned such that when said plunger is moved to its extended position, said latch surface of said trip arm moves said trip latch, causing said operating mechanism to trip.

9. The operating mechanism set forth in claim 8 wherein said trip arm is mounted to rotate about a stationary pivot with one degree of freedom, said plunger acting against said first surface of said trip arm causing said trip arm to rotate about said pivot.

10. circuit breaker comprising:
an electronic trip unit, said electronic trip unit being removable;
a contact arm having at least one movable contact, said contact arm movable between open and closed positions wherein each said at least one movable contact is in contact with a corresponding stationary contact when said contact arm is in said closed position;
an operating handle movable between on and off positions, said operating handle extending substantially up at a point between said on and off positions;
a crank operably connected to said contact arm, causing said contact arm to move between said open and closed positions when moved;
mechanism spring connected between said operating handle and said crank, causing said crank to move when discharged and when said operating handle is moved between said on and off positions;
a trip latch restraining said mechanism spring from discharging unless moved; and
means for moving the trip latch upon removal of said electronic trip unit.

11. The circuit breaker set forth in claim 10 wherein said means includes:
a trip arm movable between a first position and a second position, said trip arm including a latch surface positioned to interact with said trip latch such that as said trip arm is moved from said first position to said second position, said latch surface engages and moves said trip latch, causing said mechanism spring to discharge,
means for biasing said trip arm toward said second position, and
means for preventing said means for biasing from moving said trip arm toward said second position in response to the presence of said electronic trip unit.

12. The circuit breaker set forth in claim 11 wherein:
said means for biasing comprises a plunger and a trip spring, said trip spring biasing said plunger toward an extended position.

13. The operating mechanism set forth in claim 12 wherein:
said means for preventing comprises an extension bar that includes a first surface that interacts with said electronic trip unit, said extension bar being positioned to interact with electronic trip unit such that said electronic trip unit forces a second surface of said extension bar to depress said plunger against the force of said trip spring when said electronic trip unit is installed.

14. A circuit breaker comprising:
an electronic trip unit, said electronic trip unit being removable;
a contact arm having at least one movable contact, said contact arm movable between open and closed positions wherein each of said at least one movable contact is in contact with a corresponding stationary contact when said contact arm is in said closed position;
an operating handle movable between on and off positions, said operating handle extending substantially up at a point between said on and off positions;
a crank operably connected to said contact arm, causing said contact arm to move between said open and closed positions when moved;
mechanism spring connected between said operating handle and said crank, causing said crank to move when discharged and when said operating handle is moved between said on and off positions;
a trip latch restraining said mechanism spring from discharging unless moved;
an extension bar;
a plunger positioned to interact with said extension bar, said plunger being forced into a depressed position by said extension bar when said extension bar is forced into a first position, said extension bar being positioned proximate said plunger and a location adapted for an installation of said electronic trip unit, said extension bar positioned such that it is forced into said first position by said electronic trip unit when said electronic trip unit is installed at said location;
a trip spring urging said plunger into an extended position, said trip spring urging said extension bar into a second position when said electronic trip unit is not present; and
means for tripping said operating mechanism in response to said plunger being in said extended position.

15. The operating mechanism set forth in claim 14, wherein said extension bar is not fixedly attached to said electronic trip unit.

16. The operating mechanism set forth in claim 15, wherein said extension bar is not fixedly attached to said plunger.

17. The operating mechanism set forth in claim 16, wherein said means for tripping comprises:
a trip arm having a first surface and a latch surface, said first surface of said trip arm interacting with said plunger and said latch surface interacting with a trip latch, said trip arm being configured and positioned such that when said plunger is moved to its extended position, said latch surface of said trip arm moves said trip latch, causing said operating mechanism to trip.

18. The operating mechanism set forth in claim 17 wherein said trip arm is mounted to rotate about a stationary pivot with one degree of freedom, said plunger acting against said first surface of said trip arm causing said trip arm to rotate about said pivot.

19. An operating mechanism for a circuit breaker, said operating mechanism comprising:
an operating handle movable between on and off positions, said operating handle extending substantially up at a point between said on and off positions;
a crank for controlling a contact arm of the circuit breaker thereby causing said contact arm to move between open and closed positions when said crank moved;
a mechanism spring connected between said operating handle and said crank, causing said crank to move when discharged and when said operating handle is moved between said on and off positions;
a trip latch configured to restrain said mechanism spring from discharging unless moved;
a trip arm movable between a first position and a second position, said trip arm including a latch surface positioned to interact with said trip latch such that as said trip arm is moved from said first position to said second position, said latch surface engages and moves said trip latch, causing said mechanism spring to discharge;
a plunger and a trip spring, said trip spring biasing said plunger toward an extended position, said plunger biasing said trip arm toward said second position; and
an extension bar that includes a first surface that interacts with an electronic trip unit, said extension bar being positioned and adapted to interact with said electronic trip unit such that said electronic trip unit forces a second surface of said extension bar to depress said plunger against the force of said trip spring when said electronic trip unit is installed, said extension bar thereby preventing said plunger from moving said trip arm toward said second position in response to the presence of said electronic trip unit.

20. An operating mechanism for a circuit breaker comprising:
an extension bar;
a plunger positioned to interact with said extension bar, said plunger being forced into a depressed position by said extension bar when said extension bar is forced into a first position, said extension bar being positioned proximate said plunger and a location adapted for an installation of an electronic trip unit, said extension bar being forced into said first position when said electronic trip unit is installed at said location;
a trip spring urging said plunger into an extended position, said trip spring urging said extension bar into a second position when said electronic trip unit is not present; and
a trip arm having a first surface and a latch surface, said first surface of said trip arm interacting with said plunger and said latch surface interacting with a trip latch, said trip arm being configured and positioned such that when said plunger is moved to its extended position, said latch surface of said trip arm moves said trip latch, causing said operating mechanism to trip thereby tripping said operating mechanism in response to said plunger being in said extended position.
